(19) United States
(12) Patent Application Publication
(10) Pub. No.: US 2026/0089708 A1
(43) Pub. Date: Mar. 26, 2026

(54) TASK SCHEDULING METHOD, ELECTRONIC DEVICE, AND STORAGE MEDIUM

(71) Applicant: Beijing University of Posts and Telecommunications, Beijing (CN)

(72) Inventors: Xing ZHANG, Beijing (CN); Yang LI, Beijing (CN); Wenbo WANG, Beijing (CN)

(21) Appl. No.: 19/024,080

(22) Filed: Jan. 16, 2025

(30) Foreign Application Priority Data
Sep. 25, 2024 (CN) 202411345577.6

(51) Int. Cl. H04W 72/1263; H04W 88/08

(52) U.S. Cl. CPC H04W 72/1263; H04W 88/08

(57) ABSTRACT

The present disclosure provides a task scheduling method, electronic device, and storage medium. The method is performed by a central controller in a multi-region inter-connected edge network, including: receiving, from each of a plurality of network access points, first scheduling overhead, prediction information for task arrival, resource allocation information, and network status information; generating a computing power network graph based on the prediction information for task arrival, the resource allocation information, and the network state information of the plurality of network access points; determining a scheduling strategy for a next scheduling cycle based on the first scheduling overhead of the plurality of network access points and the computing power network graph; and sending the scheduling strategy to each of the plurality of network access points before the next scheduling cycle begins.

### CROSS REFERENCE

This disclosure claims priority to Chinese Patent Application No. 202411345577.6, entitled “Method, Apparatus, and System for Task Scheduling in Collaborative Edge Computing” filed on Sep. 25, 2024, which is incorporated by reference in its entirety.

### TECHNICAL FIELD

This disclosure relates to the field of computer technology, and in particular to a task scheduling method, electronic device, and storage medium.

### BACKGROUND

With the rapid development of Internet of Things (IoT) and 5G technologies, the demand for latency-sensitive tasks, such as face recognition and Augmented Reality (AR)/Virtual Reality (VR), is increasing. Resource-constrained terminal devices cannot process these tasks locally, and traditional cloud computing introduces significant backhaul latency, so it is not capable to provide real-time computation. Therefore, mobile edge computing (MEC) has emerged as a promising technology to support 5G service scenarios, particularly those requiring low latency.

Compared to cloud computing, edge computing nodes are resource-limited and may be overloaded when handling a large number of service requests, hence, the quality of user experience is reduced. To address this, collaborative edge computing is proposed, where edge nodes cooperate to handle tasks.

However, task scheduling among edge nodes often incurs additional overhead, primarily in terms of network costs. Therefore, cost control is essential for efficient collaborative edge computing to improve the quality of service for users.

### SUMMARY

According to one or more embodiments, a task scheduling method is provided. The method is performed by a central controller in a multi-region inter-connected edge network, the multi-region inter-connected edge network further includes a plurality of network access points respectively in a plurality of regions, and the method includes:
receiving, from each of the plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generating a computing power network graph based on the prediction information for task arrival, the resource allocation information, and the network state information of the plurality of network access points;
determining a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
sending the scheduling strategy to each of the plurality of network access points before the next scheduling cycle begins.

According to one or more embodiments, an electronic device is provided. The electronic device, comprising a memory, a processor, and a computer program stored in the memory that, when executed by the processor, causes the processor to:
receive, from each of a plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generate a computing power network graph based on the prediction information for task arrival, the resource allocation information, and the network state information of the plurality of network access points;
determine a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
send the scheduling strategy to each of the plurality of network access points before the next scheduling cycle begins.

According to one or more embodiments, a non-transitory computer-readable storage medium is provided. The non-transitory computer-readable storage medium storing a computer program causing a computer to execute a process, the process comprising:
receiving, from each of a plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generating a computing power network graph based on the prediction information for task arrival, the resource allocation information, and the network state information of the plurality of network access points;
determining a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
sending the scheduling strategy to each of the plurality of network access points before the next scheduling cycle begins.

### BRIEF DESCRIPTION OF THE DRAWINGS

FIG. 1 is a schematic diagram of the task scheduling method performed by a network access point according to an embodiment of this disclosure.

FIG. 2 is a schematic diagram of another task scheduling method performed by a network access point in the embodiment of this disclosure.

FIG. 3 is a schematic diagram of the process for determining the first scheduling overhead corresponding to a service according to an embodiment of this disclosure.

FIG. 4 is a schematic diagram of the task scheduling method performed by the central controller according to an embodiment of this disclosure.

FIG. 5 is a schematic diagram of the computing power network graph according to an embodiment of this disclosure.

FIG. 6 is a schematic diagram illustrating the process for determining the scheduling strategy according to an embodiment of this disclosure.

FIG. 7 is a schematic diagram of a weighted directed acyclic graph without intermediate nodes according to an embodiment of this disclosure.

FIG. 8 is a schematic diagram of a weighted directed acyclic graph with intermediate nodes according to an embodiment of this disclosure.

FIG. 9 is a schematic diagram of the multi-region inter-connected edge network according to an embodiment of this disclosure.

FIG. 10 is a schematic diagram of the structure of a task scheduling apparatus according to an embodiment of this disclosure.

FIG. 11 is a schematic diagram of the structure of another task scheduling apparatus according to an embodiment of this disclosure.

FIG. 12 is a schematic diagram of an electronic device provided according to an embodiment of this disclosure.

### DESCRIPTION OF EMBODIMENTS

The following will provide a clear and complete description of the technical solutions in the embodiments of this disclosure, in conjunction with the accompanying drawings. It is evident that the described embodiments represent only a portion of the embodiments of this disclosure, and not all possible embodiments. All other embodiments derived by those skilled in the art without requiring inventive efforts, based on the embodiments provided in this disclosure, are within the scope of protection of this disclosure.

The terms “first,” “second,” “third,” “fourth,” etc., as used in the specification, claims, and drawings of the present invention (if present), are intended to distinguish similar objects rather than to describe any sequential or chronological order. It should be understood that such terms can be interchanged under appropriate circumstances, such that the embodiments of the invention described herein can be implemented in sequences other than those illustrated or described. Additionally, the terms “include,” “comprise,” and their variations are intended to encompass non-exclusive inclusion. For example, a process, method, system, product, or device comprising a series of steps or elements is not limited to those explicitly listed, but may include other steps or elements that are not explicitly listed or are inherent to the process, method, product, or device.

The following provides a detailed description of the technical solutions of the present invention through specific embodiments. The following embodiments may be combined, and detailed explanations may be omitted in certain embodiments for identical or similar concepts or processes.

Existing edge collaboration implementations in related technologies have not adequately considered scheduling overhead. Task scheduling between edge nodes often incurs additional overhead, primarily in terms of network costs. It requires to enhance user service quality to the greatest extent while maintaining cost control. The main challenge in collaborative edge computing lies in achieving optimal task scheduling during each scheduling cycle, especially when the task requests triggered by the user is unpredictable and the long-term cost expectation needs to be satisfied.

To address the above issues, this disclosure discloses a task scheduling method, applied in a multi-region inter-connected edge network for collaborative edge computing. At the end of each scheduling cycle, the scheduling strategy for each service is determined based on the scheduling overhead, prediction information for task arrival, resource allocation information, and network state information obtained from the network access points. This scheduling strategy is used to guide the scheduling of task requests in the next scheduling cycle. This approach decomposes a long-term optimization problem into individual scheduling cycles, so that scheduling overhead may be considered within each cycle. It enables efficient collaborative edge computing while controlling scheduling overhead. Furthermore, it addresses the challenge of spatio-temporally non-uniform task requests coming from users and the resultant variant system state in a multi-region inter-connected edge network. As a result, a balance between short-term performance and long-term constraints for scheduling can be achieved.

In embodiments of the present disclosure, a multi-region inter-connected edge network includes a plurality of regions, such as factories or campuses. Each region is equipped with an edge computing resource pool, and the edge computing resource pools among these regions are connected via a local-area network (LAN). Multiple services may be deployed across these regions, and resources in the edge computing resource pool may be allocated to each deployed service. In some embodiments, one edge computing resource pool may include at least one edge computing server. Through virtualization, the at least one edge computing server may be virtualized as one edge computing resource pool externally.

In embodiments of the present disclosure, the deployment of services and resource allocation are based on historical statistics or other strategies, which may be not restricted in this disclosure. Embodiments of the present disclosure provides a method for optimal scheduling of task requests in each region during each scheduling cycle, after the service deployment and resource allocation are completed.

In embodiments of the present disclosure, a service corresponds to an application, the type of the application may be but not limited to a video rendering application, an Artificial Intelligence (AI) reasoning application, etc., such as face recognition, VR. And a task request is triggered by a user when using the application via a user terminal, for example, the user requests to recognize an image, or paly a VR game.

In embodiments of the present disclosure, there is a demand for a service in terms of computing power and/or latency. For the services with low sensitivity to the computing power and latency, the edge computing may not be applied.

In embodiments of the present disclosure, the process of determining the scheduling strategy may be performed independently for each of a plurality of services. Hence, the steps of determining the scheduling strategy and then using the scheduling strategy in the following embodiments are given for a specific service. For other services, the steps of determining and using may be the same.

In embodiments of the present disclosure, a scheduling cycle can be configured by analyzing the arrival patterns of historical requests for the service or adaptively adjusted through online learning. Each service's scheduling cycle can be the same or different, as the scheduling processes for different services are independent. In some embodiments, a same scheduling cycle may be used as an example in the subsequent discussion.

Users in each region can initiate task requests to a specific service deployed in the multi-region inter-connected edge network at any time. The task requests first arrive at the network access point of the corresponding region. It is necessary to determine the service corresponding to the task request. If the corresponding service is one deployed in the multi-region inter-connected edge network, the task request is scheduled by a network access point in a region where the service is deployed, according to a scheduling strategy corresponding to the service and determined for a current scheduling period. If the corresponding service is not deployed in the multi-region inter-connected edge network, the task request is handled using the processing methods described in related technologies.

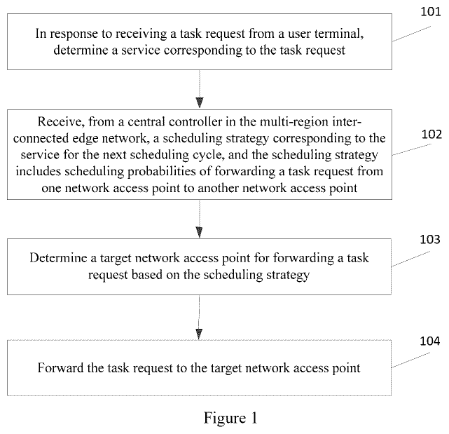

FIG. 1 is a schematic diagram of the task scheduling method performed by a network access point in a multi-region inter-connected edge network according to an embodiment of this disclosure, including the following steps:
Step 101: In response to receiving a task request from a user terminal, determine a service corresponding to the task request.
Step 102: Receive, from a central controller in the multi-region inter-connected edge network, a scheduling strategy corresponding to the service for the next scheduling cycle, and the scheduling strategy includes scheduling probabilities of forwarding a task request from one network access point to another network access point.

In some embodiments, before the current scheduling cycle starts, the central controller has distributed the scheduling strategies of all services to each network access point. Hence, in the current scheduling cycle, the network access point may retrieve, from the scheduling strategies of all services, the scheduling strategy corresponding to the service determined in step 101 for the next scheduling cycle.

In some embodiments, the central controller generates a computing power network graph based on the prediction information for task arrival, the resource allocation information, and the network state information of the plurality of network access points. The central controller determines a scheduling strategy for a next scheduling cycle based on the first scheduling overhead of the plurality of network access points and the computing power network graph.

In some embodiments, the first scheduling overhead represents a sum of scheduling overhead caused when the respective network access point scheduling a plurality of task requests for a service within a previous scheduling cycle.

In some embodiments, the prediction information for task arrival indicates a predicted number of task requests for the i-th service arriving at the j-th network access point during the next scheduling cycle. Here, j is an integer, greater than 0 and no larger than the total number of network access points in the multi-region inter-connected edge network, and i is an integer, greater than 0 and no larger than the total number of services deployed in the multi-region inter-connected edge network.

In some embodiments, the resource allocation information indicates an amount of computing resources in the j-th edge computing resource pool allocated to the i-th service. In some embodiments, each region may deploy one network access point and one edge computing resource pool, and the number of computing resource pools is equal to the number of network access points. If multiple edge computing resource pools are deployed in a single region, the amount of allocated computing resource can be specified based on the relationship between specific edge computing resource pools and services.

In some embodiments, the network status information includes a bandwidth for transmission between the m-th region and the n-th region, where m and n are different integers, greater than 0, and less than the total number of regions in the multi-region inter-connected edge network.

When there is one network access point in each region, the bandwidth may refer to the bandwidth for transmission between one network access point to another network access point. A network access point measures the bandwidth between itself and another network access point, to represent the bandwidth between its region and the region of another network access points. The network bandwidth from a network access point to itself can be defined as the maximum allowable bandwidth.
Step 103: Determine a target network access point for forwarding a task request based on the scheduling strategy.
Step 104: Forward the task request to the target network access point.

In some embodiments, the central controller determines a scheduling strategy for a next scheduling cycle based on the first scheduling overhead of the plurality of network access points and the computing power network graph, including:
calculating a second scheduling overhead for the next scheduling cycle based on the first scheduling overhead and a pre-determined long-term-average scheduling overhead;
determining the scheduling strategy based on the second scheduling overhead and the computing power network graph.

The pre-determined long-term-average scheduling overhead refers to an average scheduling overhead over a relatively long period, e.g., a number of scheduling periods, from a long-term perspective.

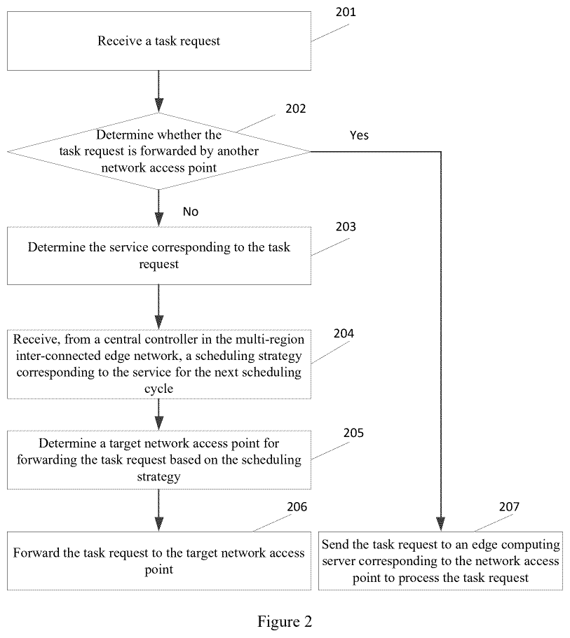

FIG. 2 is a schematic diagram of another task scheduling method performed by a network access point in the embodiment of this disclosure, including the following steps:
Step 201: Receive a task request.

The task request may be sent from a user terminal when a user operates the user terminal to use an application corresponding to a service, or forwarded from another network access point.
Step 202: Determine whether the task request is forwarded by another network access point. If yes, proceed to step 207; otherwise, proceed to step 203.
Step 203: Determine the service corresponding to the task request.
Step 204: Receive, from a central controller in the multi-region inter-connected edge network, a scheduling strategy corresponding to the service for the next scheduling cycle, and the scheduling strategy includes scheduling probabilities of forwarding a task request from one network access point to another network access point.
Step 205. Determine a target network access point for forwarding the task request based on the scheduling strategy.
Step 206. Forward the task request to the target network access point.

Then, in response to the task request coming from one network access point, the target network access point sends the task request to its edge computing server in a same region to process the task request.
Step 207. Send the task request to an edge computing server corresponding to the network access point to process the task request.

In some embodiments, the edge computing server and the network access point are in the same region.

In some embodiments, an application corresponding to the service is installed locally in the edge computing server, and the application is invoked by the edge computing server to process the task request.

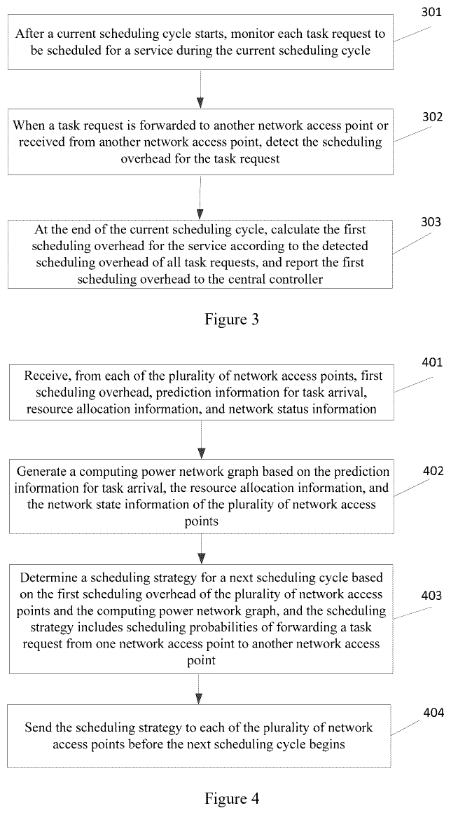

FIG. 3 is a schematic diagram of the process for determining the first scheduling overhead corresponding to a service according to an embodiment of this disclosure. The process is performed by the network access point, including the following steps:
Step 301. After a current scheduling cycle starts, monitor each task request to be scheduled for a service during the current scheduling cycle.
Step 302. When a task request is forwarded to another network access point or received from another network access point, detect the scheduling overhead for the task request, including transmission overhead and signaling overhead between two network access points.
Step 303. At the end of the current scheduling cycle, calculate the first scheduling overhead for the service according to the detected scheduling overhead of all task requests, and report the first scheduling overhead to the central controller.

In this embodiment, each network access point accumulates the scheduling overhead for each service during a scheduling cycle and reports it to the central controller.

FIG. 4 is a schematic diagram of the task scheduling method performed by the central controller according to an embodiment of this disclosure. A multi-region inter-connected edge network includes the central controller and a plurality of network access points respectively in a plurality of regions. The method includes the following steps:
Step 401. Receive, from each of the plurality of network access points, first scheduling overhead, prediction information for task arrival, resource allocation information, and network status information.

In some embodiments, the first scheduling overhead represents a sum of scheduling overhead caused when the respective network access point scheduling a plurality of task requests for a service within a previous scheduling cycle. The first scheduling overhead corresponds to the specific service, i.e., for each service, a value of the first scheduling overhead is received.

In some embodiments, the prediction information for task arrival indicates a predicted number of task requests for the service arriving at the respective network access point during the next scheduling cycle. Those task requests correspond to a single service, i.e., for each service, there is an individual prediction information for task arrival.

In some embodiments, the resource allocation information indicates an amount of computing resources in the edge computing resource pool allocated to the service, wherein the edge computing resource pool and the respective network access point are located in the same region. For all task requests corresponding to a same service, the resource allocation information may be the same.

In some embodiments, the network status information includes at least one bandwidth between the respective network access point and other network access point(s).
Step 402. Generate a computing power network graph based on the prediction information for task arrival, the resource allocation information, and the network state information of the plurality of network access points.

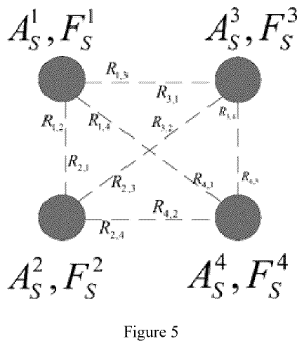

FIG. 5 is a schematic diagram of the computing power network graph according to an embodiment of this disclosure. In FIG. 5, the total number of regions in the multi-region inter-connected edge network is 4, and there is one network access point in each region. “S” stands for the service,

$$“ {A}_{S}^{n} ”$$

represents the predicted number of task requests arriving in the next scheduling cycle at the n-th network access point, which is predicted based on service S's historical request information for task arrival.

$${F}_{S}^{n}$$

represents the amount of computational resources allocated to service S by the edge resource pool in the n-th region. Rₘⁿ represents the network bandwidth between the m-th region and the n-th region, or the network bandwidth between the m-th network access point and the n-th network access point when there is one network access point in each region.
Step 403. Determine a scheduling strategy for a next scheduling cycle based on the first scheduling overhead of the plurality of network access points and the computing power network graph, and the scheduling strategy includes scheduling probabilities of forwarding a task request from one network access point to another network access point.

In an embodiment, the determining includes:
calculating a second scheduling overhead for the next scheduling cycle based on the first scheduling overhead and a pre-determined long-term-average scheduling overhead;
determining the scheduling strategy based on the second scheduling overhead and the computing power network graph.

In an embodiment, suppose there are M network access points. For service S, during the t-th scheduling cycle, the m-th network access point, according to the scheduling strategy obtained from the central controller, a network access point forwards each of the task requests for service S to other network access points and then to be processed by the corresponding edge computing servers. Once a task request is scheduled, the network access point monitors the scheduling overhead caused when forwarding that task request, including the transmission overhead and signaling overhead between two network access points. At the end of the t-th scheduling cycle, each network access point accumulates the scheduling overhead generated by forwarding (or scheduling) task requests for service S during this cycle, to obtain the first scheduling overhead. The first scheduling overhead is then reported to the central controller.

Assuming that at the start of the t-th scheduling cycle, the second scheduling overhead for service S is Q_{S}(t), and the first scheduling overhead at the m-th network access point within the t-th scheduling cycle is

$${E}_{S}^{m} ( t ) ,$$

with the time duration of one scheduling cycle being T_{P} and the service's long-term-average scheduling overhead being

$${E}_{S}^{e xp} ,$$

the second scheduling overhead predicted for the (t+1)-th scheduling cycle for this service may be calculated as:

$${Q}_{S} ( t + 1 ) = \{ \begin{matrix}max \{ {Q}_{S} ( t ) + {\sum }_{m = 1}^{m = M} {E}_{S}^{m} ( t ) / {T}_{P} - {E}_{S}^{e xp} , 0 \} & if t > 0 \\ 0 & if t = 0\end{matrix} \qquad ( 1 )$$

In an embodiment, the process of determining the scheduling strategy for the next scheduling cycle may be performed based on a modified genetic model. The computing power network graph of service S and Q_{S}(t) are used as inputs to the modified genetic model, which outputs the scheduling strategy for service S to be used for the next scheduling cycle.

Assume there are M network access points, the scheduling strategy for service S is expressed as a matrix of scheduling probabilities:

$${P}_{S} = [ \begin{matrix}{p}_{11}^{S} & {p}_{12}^{S} & {p}_{13}^{S} & … & {p}_{1 M}^{S} \\ {p}_{21}^{S} & {p}_{22}^{S} & {p}_{23}^{S} & … & {p}_{2 M}^{S} \\ … & … & … & & … \\ {p}_{M 1}^{S} & {p}_{M 2}^{S} & {p}_{M 3}^{S} & … & {p}_{MM}^{S}\end{matrix} ] \qquad ( 2 )$$

wherein

$${p}_{mn}^{S}$$

represents the probability that the m-th network access point forwards the task request to the n-th network access point. Therefore, the sum of probabilities in each row is equal to 1.
Step 404: Send the scheduling strategy to each of the plurality of network access points before the next scheduling cycle begins.

Based on the matrix in the above equation (2), the network access point determine a row of probabilities corresponding to itself, and generate a random number to compare with probability intervals determined by all the elements in the row. For example, for the m-th network access point, the row

$$[ \begin{matrix}{p}_{m 1}^{S} & {p}_{m 2}^{S} & {p}_{m 3}^{S} & … & {p}_{m M}^{S}\end{matrix} ]$$

may provide M probability intervals, i.e.,

$$[ 0 , {p}_{m 1}^{S} ] , [ {p}_{m 1}^{S} , {p}_{m 1}^{S} + {p}_{m 2}^{S} ] , [ {p}_{m 1}^{S} + {p}_{m 2}^{S} , {p}_{m 1}^{S} + {p}_{m 2}^{S} + {p}_{m 3}^{S} ] , … , [ {p}_{m 1}^{S} + {p}_{m 2}^{S} + … + {p}_{m ( M - 1 )}^{S} , 1 ] .$$

A probability interval where the random number is located is determined to indicate the target network access point. For example, for the 1^{st} network access point, the row

$$[ \begin{matrix}{p}_{11}^{S} & {p}_{12}^{S} & {p}_{13}^{S} & {p}_{14}^{S}\end{matrix} ] = [ 0.1 , 0.35 , 0.4 , 0.15 ] ,$$

and the random number is 0.417. As a result, 0.417>0.1, and 0.417<(0.1+0.35). Hence, the 2^{nd} probability interval is the interval where the random number is located, so that the 2^{nd} network access point is determined as the target network access point.

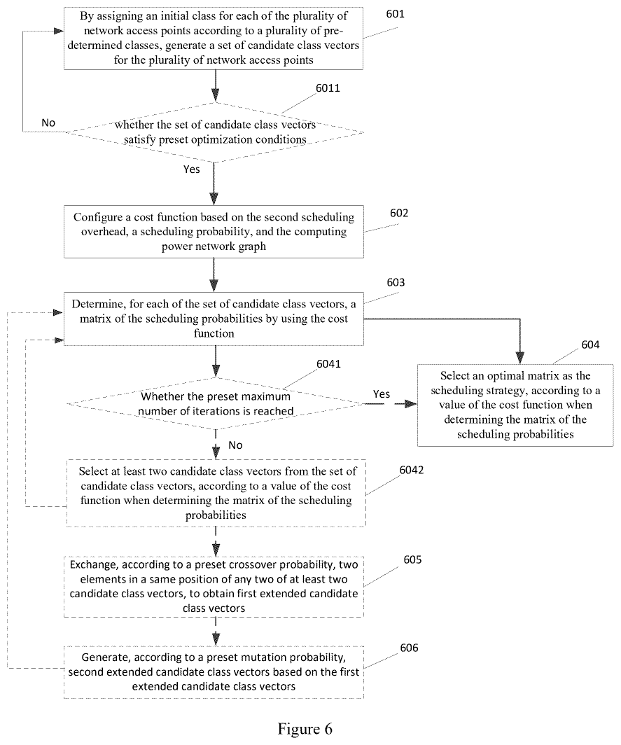

FIG. 6 is a schematic diagram illustrating the process for determining the scheduling strategy according to an embodiment of this disclosure, including the following steps:
Step 601: By assigning an initial class for each of the plurality of network access points according to a plurality of pre-determined classes, generate a set of candidate class vectors for the plurality of network access points.

The pre-determined classes comprise: a source node, a sink node, and an isolated node, the source node has only an out-degree and no in-degree, the sink node has only an in-degree and no out-degree, and the isolated node has neither an out-degree nor an in-degree.

In this step, initialize a class for each network access point, i.e., determine each network access point to be a source node, a sink node, or an isolated node.

In specific, a network access point being the source node may schedule (forward) task requests to other network access points, but not receive any task requests from other network access points. A network access point being the sink node may receive task requests from other network access points but not schedule any task requests to other network access points. A network access point being the isolated node may neither receive task requests nor schedule task requests, i.e., all its outgoing and incoming weights (i.e., probabilities) are zero. If nodes of other types exist, the corresponding scheduling strategy may be verified not to be optimal.

Suppose there are M regions. For service S, the generated candidate class vector can be represented as:

$${O}_{S} = [ {o}_{s}^{1} , {o}_{s}^{2} , … {o}_{s}^{M} ] ,$$

where

$${o}_{s}^{m} ∈ \{ 0 , 1 , 2 , \}$$

and 0 represents a source node, 1 represents a sink node, and 2 represents an isolated node. Additionally, if

$${F}_{S}^{m} = 0 ,$$

then

$${o}_{s}^{1} = 0.$$

If O_{S} contains any element equal to 1, it must also contain at least one element equal to 0. This means that the existence of a sink node guarantees the existence of a source node.

In embodiments of the present disclosure, the set of candidate class vectors define the search space for the final scheduling strategy. In order to reduce the search space for the optimal scheduling strategy, the method further includes:
Step 6011: Determine whether the set of candidate class vectors satisfy preset optimization conditions, if yes, proceed to step 602; otherwise, return to step 601.

First, for each candidate class vector, construct an initial matrix of the scheduling probabilities according to the respective candidate class vector, i.e., construct an initial P_{S} in the above equation (2) based on O_{S}; and determine a scheduling strategy graph corresponding to the initial matrix.

Second, the preset optimization conditions may include the following three conditions:

The first condition: the scheduling strategy graph is a weighted directed acyclic graph (DAG), and there are no intermediate nodes.

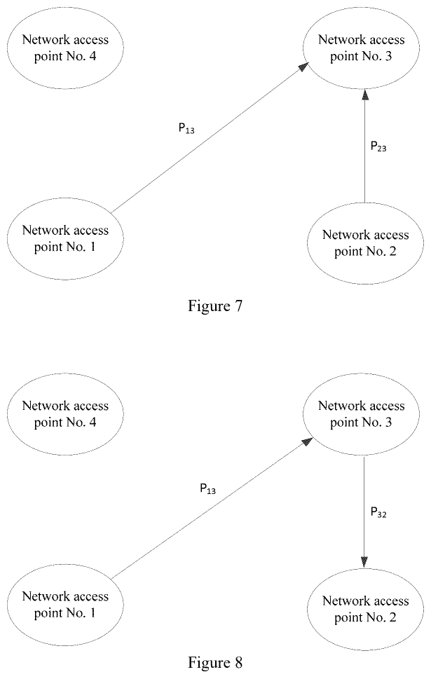

FIG. 7 is a schematic diagram of a weighted directed acyclic graph without intermediate nodes according to an embodiment of this disclosure. In FIG. 7, four network access points are represented as four nodes, and there are no intermediate nodes. A sink node refers to a node that only has incoming edges, i.e., all the edges point towards itself, e.g., the node corresponding to the network access point No. 3. A source node refers to a node that only has outgoing edges, i.e., all the edges point towards other nodes, e.g., the nodes corresponding to the network access points No. 1 and No. 2. The node corresponding to the network access point No. 4 is an isolated node.

The weights labeled on the edges of the graph represent elements in the matrix of the scheduling probabilities, as given in the above equation (2). For example, the weight from the network access point No. 1 to the network access point No. 3 is P₁₃, and the weight from the network access point No. 2 to the network access point No. 3 is P₂₃.

For the directed acyclic graph, the term “directed” means the connections between nodes are directed edges, i.e., the edges have a direction from one node to another. The term “acyclic” means that starting from any vertex, one cannot return to the starting vertex along the directed edges, thus no loop is formed. An intermediate node is a node that has both a predecessor node (i.e., other vertices connected to it by incoming edges) and a successor node (i.e., it is connected to other vertices via outgoing edges).

FIG. 8 is a schematic diagram of a weighted directed acyclic graph with intermediate nodes according to an embodiment of this disclosure. In FIG. 8, the four network access points are represented as four nodes, and the node corresponding to the network access point No. 3 is an intermediate node.

In the scheduling strategy graph, the weighted edges correspond to probabilities greater than 0. The probability of processing the task requests locally (i.e., not scheduling the tasks to other network access points) is equal to 1 minus the sum of the weights of all outgoing edges. The remaining probabilities are set to 0.

The second condition: for the scheduling strategy of a specific service, network access points where the service is not deployed are only source nodes. This can be expressed as: if

$${F}_{S}^{m} = 0 ,$$

then

$${o}_{s}^{1} = 0.$$

The third condition: for a network access point belonging to the source node, if the service is deployed in that network access point, the sum of the weights of all outgoing edges cannot exceed 1; otherwise, the sum of the weights of all outgoing edges must be equal to 1. This can be expressed as: if

$${o}_{s}^{n} = 0 and {F}_{s}^{n} > 0 ,$$

then

$${p}_{nn}^{S} \geq 0 ;$$

if

$${o}_{s}^{n} = 0 and {F}_{s}^{n} = 0 ,$$

then

$${p}_{nn}^{S} = 0.$$

Step 602: Configure an objective function based on the second scheduling overhead, a scheduling probability, and the computing power network graph.

In an embodiment, taking service S as an example, the objective function for service S may be determined by the Lyapunov drift plus penalty function, which incorporates the second scheduling overhead into the delay penalty. The objective function may be configured as:

$${min}_{{P}_{S}} {VT}_{S} ( {P}_{S} ) + {Q}_{S} ( t ) ( \frac{{E}_{S} ( {P}_{S} )}{{T}_{P}} - {E}_{S}^{exp} ) \qquad ( 3 )$$

$$s . t . {\sum }_{m = 1}^{m = M} {p}_{nm}^{S} = 1 \qquad ( 4 )$$

wherein P_{S} represents the scheduling strategy, i.e., the matrix of scheduling probabilities to be determined for service S, given in the above equation (2);
T_{S}(P_{S}) denotes an expected task processing delay when the scheduling probabilities P_{S} are applied under the computing power network graph. Based on distributions of task requests, resource distributions, and scheduling probabilities, the expected number of task requests to be processed by edge computing servers can be derived, and the expected task processing delay can be obtained;
V is a hyperparameter as a penalty coefficient, and when the value of V is larger, a larger weight is put on T_{S}(P_{S}), and when the value of V is smaller, a larger weight is put on the scheduling overhead;
E_{S}(P_{S}) represents an expected task scheduling overhead using the matrix of scheduling probabilities under the computing power network graph;
the constraint

$$s . t . {\sum }_{m = 1}^{m = M} {p}_{nm}^{S} = 1$$

indicates that the sum of each row in the matrix is equal to 1.
Step 603: Determine, for each of the set of candidate class vectors, a matrix of the scheduling probabilities by using the objective function.
Step 604: Select an optimal matrix as the scheduling strategy, according to a value of the objective function when determining the matrix of the scheduling probabilities.

In some embodiments, for iteratively determining the scheduling strategy, the method further includes:
Step 6041: Determine whether the preset maximum number of iterations is reached. If yes, proceed to step 604; otherwise, proceed to step 6042.
Step 6042: Select at least two candidate class vectors from the set of candidate class vectors, according to a value of the objective function when determining the matrix of the scheduling probabilities. Then, the selected at least two candidate class vectors are returned to step 603 as a new input.

In some embodiments, further processing may be added following the step 6042 to optimize the selected candidate class vectors in each iteration, including the following steps:
Step 605: Exchange, according to a preset crossover probability, two elements in a same position of any two of at least two candidate class vectors, to obtain first extended candidate class vectors.

According to the preset crossover probability P_{cross}, generate a random number Random1 between 0 and 1. If Random1<P_{cross}, exchange two elements in a same position of two candidate class vectors; otherwise, no operation is performed.

The position to be exchanged corresponds to a network access point in a region where the service is deployed, because the region where the service is not deployed can only act as a source node. The network access point as the source node does not process the task requests locally, and must schedule all external task requests for the service to other network access points that belong to the sink nodes for processing the external task requests.

For example, for four network access points, two candidate class vectors are {0, 2, 1, 0} and {1, 2, 0, 0}. A same service is deployed in the 3^{rd} region. Thus, according to Random1<P_{cross}, two 3^{rd} elements are exchanged to obtain the first extended candidate class vectors {0, 2, 0, 0} and {1, 2, 1, 0}.

In another example, the specific service is deployed in multiple regions, e.g., the 1^{st} region, the 2^{nd} region, and the 3^{rd} region. When Random1<P_{cross}, one region is selected randomly from the multiple regions, e.g., the 3^{rd} region is selected for the following exchange.
Step 606: Generate, according to a preset mutation probability, second extended candidate class vectors based on the first extended candidate class vectors. Then, proceed to Step 603.

For each of the first extended candidate class vectors, generate a random number Random2 between 0 and 1 based on the preset mutation probability P_mutation. If Random2<P_mutation, randomly select a position between 1 and M (the number of network access points), and modify the corresponding element at that position to a value from the set {0, 1, 2}, ensuring that the new value is different from the original value; otherwise, no operation is performed.

As described above, for each candidate class vector O_{S}, an initial P_{S} in the above equation (2) is constructed. The step 603 aims to find the optimal weight value for each edge, which corresponds to the scheduling probability between two network access points.

In some embodiments, step 603 may be performed through a harmony search algorithm. The specific solution process is as follows:
Step 6031: Initialize a number of iterations, a harmony memory size (HMS), a harmony memory consideration rate (HMCR), a pitch adjustment rate (PAR), and an adjustment bandwidth (BW). Each element in the initial matrix is determined as an initial value of a harmony variable.
Step 6032: In each iteration, for each harmony variable, generate a random number between 0 and 1. If the random number is smaller than the initial value of the harmony variable, randomly select a value from the harmony memory to replace the initial value; otherwise, randomly select a value within the allowed range [0, 1] for the harmony variable.
Step 6033: Apply a pitch adjustment with a probability of PAR to the harmony variable, adjusting its value by a disturbance within the bandwidth BW. After the adjustment, ensure that the disturbed value remains within its allowed range [0, 1].
Step 6034: Transform the new values of all the harmony variables into a matrix of scheduling probabilities, and calculate the value of objective function as given in the above equation (3). Determine whether the matrix is better than the worst solution (i.e., harmony) recorded in the harmony memory in terms of the value of the objective function. If the matrix is better, and the number of harmonies recorded in the harmony memory has reached the HMS, replace the worst solution in the harmony memory with the matrix. Otherwise, the harmony corresponding to the matrix is added into the harmony memory.
Step 6035: Check if the stopping criteria are met. If yes, proceed to Step 6036; otherwise, return to Step 6032.

The stopping criterion is whether the current number of iterations has reached the predefined maximum number of iterations.
Step 6036: Return the optimal matrix as the scheduling strategy and the corresponding value of the objective function.

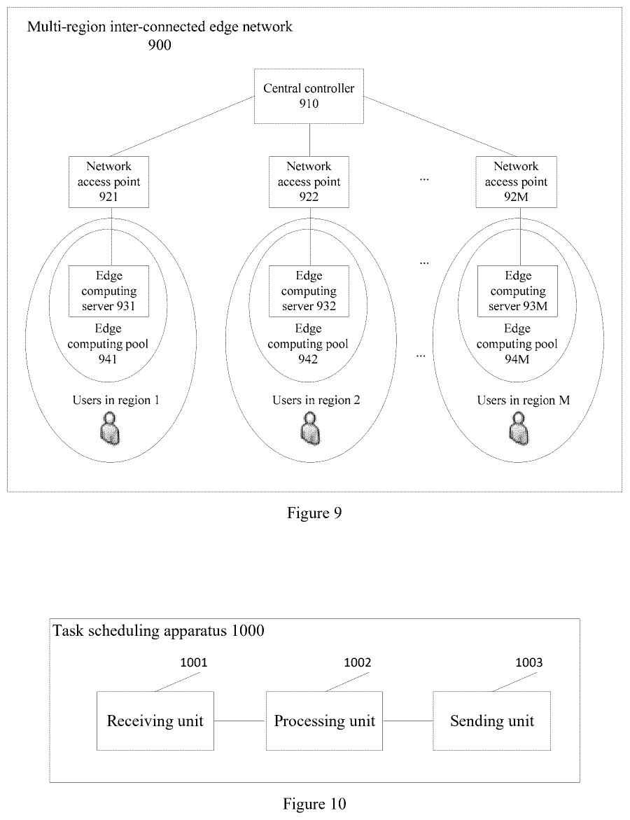

FIG. 9 is a schematic diagram of the multi-region inter-connected edge network according to an embodiment of this disclosure. The multi-region inter-connected edge network 900 includes a central controller 910, a plurality of network access points 921, . . . , 92M respectively in M regions, and in each region, there are one edge computing pool 941, . . . , 94M including pooled computing resources for the respective region. and each edge computing pool 941, . . . , 94M includes at least one edge computing server 931, . . . , 93M, respectively. In each region, there are a plurality of users to send a task request when using an application corresponding to a service deployed in the respective region.

The network access point 921, . . . , 92M, in response to receiving a task request from a user terminal, determines a service corresponding to the task request, receives, from a central controller in the multi-region inter-connected edge network, a scheduling strategy corresponding to the service for the next scheduling cycle, determines a target network access point for forwarding a task request based on the scheduling strategy, and forward the task request to the target network access point.

The central controller 910 receives, from each of the plurality of network access points, first scheduling overhead, prediction information for task arrival, resource allocation information, and network status information, generates a computing power network graph based on the prediction information for task arrival, the resource allocation information, and the network state information of the plurality of network access points, determines a scheduling strategy for a next scheduling cycle based on the first scheduling overhead of the plurality of network access points and the computing power network graph; and sends the scheduling strategy to each of the plurality of network access points before the next scheduling cycle begins.

Embodiments of this disclosure present a task scheduling strategy for collaborative edge computing guided by Lyapunov optimization theory, addressing the spatial-temporal non-uniformity and time-varying nature of user request distribution across multiple regions. This disclosure resolves a long-term stochastic optimization problem down to each scheduling period, requiring neither future system state information nor knowledge of probability distributions of random events.

A model of the computing power network graph is constructed based on resource allocation information, network state information, and prediction information for task arrival in multi-region inter-connected edge networks. Based on this model, an improved genetic algorithm and harmony search algorithm are utilized to solve optimal task scheduling decisions within each scheduling period.

Embodiments of this disclosure are applicable to systems under time-varying environments, load balancing in multi-region inter-connected edge networks is achieved, overall response time for user tasks is reduced, and the long-term average cost of task scheduling is controlled.

All the above optional technical solutions can be combined in any manner to form optional embodiments of this disclosure, and will not be repeated here.

An embodiment of this disclosure also provides a task scheduling apparatus, which is applied to a central controller in a multi-region inter-connected edge network. FIG. 10 is a structural diagram of a task scheduling apparatus according to an embodiment of this disclosure. The apparatus 1000 includes:

A receiving unit 1001, is configured to receive, from each of the plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle.

A processing unit 1002, is configured to generate a computing power network graph based on the prediction information for task arrival, the resource allocation information, and the network state information of the plurality of network access points; and determines a scheduling strategy for a next scheduling cycle based on the first scheduling overhead of the plurality of network access points and the computing power network graph, wherein the scheduling strategy comprises scheduling probabilities of forwarding a task request from one network access point to another network access point.

A sending unit 1003, is configured to send the scheduling strategy to each of the plurality of network access points before the next scheduling cycle begins.

In another example, the processing unit 1002, is configured to calculate a second scheduling overhead for the next scheduling cycle based on the first scheduling overhead and a pre-determined long-term-average scheduling overhead; and determine the scheduling strategy based on the second scheduling overhead and the computing power network graph.

In another example, the scheduling strategy is represented by a matrix of the scheduling probabilities, and the processing unit 1002, is configured to by assigning an initial class for each of the plurality of network access points according to a plurality of pre-determined classes, generate a set of candidate class vectors for the plurality of network access points, wherein the pre-determined classes comprise: a source node, a sink node, and an isolated node, the source node has only an out-degree and no in-degree, the sink node has only an in-degree and no out-degree, and the isolated node has neither an out-degree nor an in-degree; configure an objective function based on the second scheduling overhead, a scheduling probability, and the computing power network graph; determine, for each of the set of candidate class vectors, the matrix of the by using the objective function; select an optimal matrix as the scheduling strategy, according to a value of the objective function when determining the matrix of the scheduling probabilities.

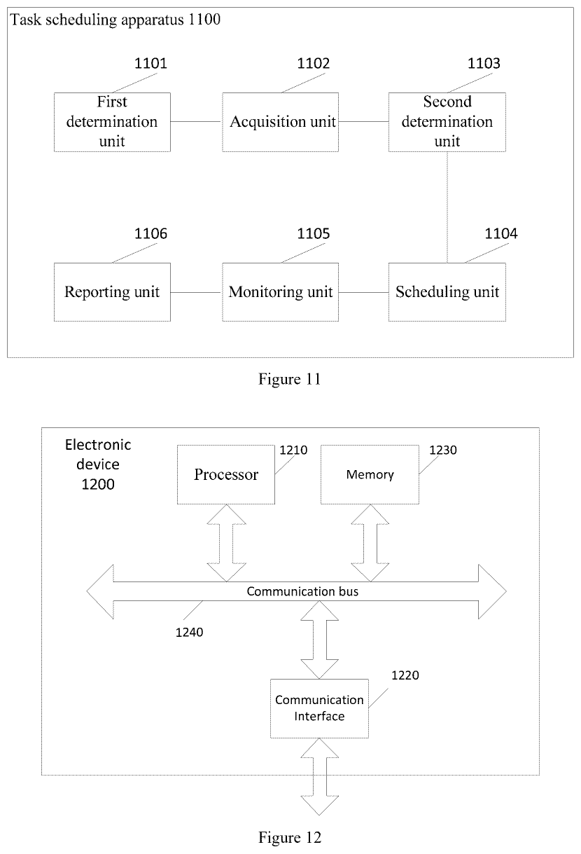

The embodiment of the present application also provides another task scheduling apparatus, applied to a network access point in a multi-region inter-connected edge network. FIG. 11 is a schematic diagram of the structure of another task scheduling apparatus according to an embodiment of this disclosure. The apparatus 1100 includes:

The first determination unit 1101 is configured to receive a task request from a user terminal, and determine the service corresponding to the task request.

The acquisition unit 1102 is configured to receive, from a central controller in the multi-region inter-connected edge network, a scheduling strategy corresponding to the service for the next scheduling cycle.

The second determination unit 1103 is configured to determine a target network access point for forwarding the task request based on the scheduling strategy.

The scheduling unit 1104 is configured to forward the task request to the target network access point.

In another example, the apparatus 1100 further includes:

The monitoring unit 1105 is configured to determine whether a task request is received from another network access point, and in response to determining the task request is received from another network access point, send the task request to an edge computing server in a same region to process the task request.

The reporting unit 1106 is configured to at the end of a current scheduling cycle, calculate the first scheduling overhead for each service and report the first scheduling overhead to the central controller.

The units in the above embodiments can be integrated into a single unit or deployed separately; they can be merged into one unit or further split into multiple sub-units.

In another embodiment, an electronic device is also provided, which includes a memory, a processor, and a computer program stored in the memory and executable on the processor. When the processor executes the program, the task scheduling method for collaborative edge computing is implemented.

In another embodiment, a non-transitory computer-readable storage medium is also provided, on which computer instructions are stored. When the instructions are executed by a processor, the task scheduling method for collaborative edge computing is implemented.

FIG. 12 is a schematic diagram of an electronic device provided by the embodiment of the present invention. As shown in FIG. 12, the electronic device 1200 may include: a processor 1210, a communication interface 1220, a memory 1230, and a communication bus 1240, where the processor 1210, communication interface 1220, and memory 1230 communicate with each other via the communication bus 1240. The processor 1210 can invoke logic instructions stored in the memory 1230 to execute the following methods described in the above embodiments.

In addition, the logic instructions in the aforementioned memory 1230 can be implemented in the form of software functional units and, when sold or used as an independent product, can be stored in a non-transitory computer-readable storage medium. Based on this understanding, the technical solution of the present invention, or the part that contributes to the existing technology, can be embodied as a software product. The computer software product is stored in a storage medium and includes several instructions to enable a computer device (which can be a personal computer, server, or network device, etc.) to execute all or part of the steps of the methods described in various embodiments of the present invention. The aforementioned storage medium includes: USB drives, external hard drives, read-only memory (ROM), random access memory (RAM), magnetic disks, optical disks, and other media that can store program code.

The device embodiments described above are merely illustrative. The units described as separate components may or may not be physically separate. The components displayed as units may or may not be physical units; they could be located in one place or distributed across multiple network units. Depending on actual needs, some or all of the modules can be selected to achieve the objectives of the embodiment. A person skilled in the art can understand and implement this without requiring any creative effort.

From the description of the above embodiments, those skilled in the art can clearly understand that each embodiment can be implemented using software and the necessary general-purpose hardware platform, or alternatively, through hardware. Based on this understanding, the technical solution, or the part that contributes to the existing technology, can be embodied as a software product. The computer software product can be stored in a non-transitory computer-readable storage medium, such as ROM/RAM, magnetic disks, optical discs, etc., and includes several instructions to enable a computer device (which can be a personal computer, server, network device, etc.) to execute the methods described in each embodiment or some portions of the embodiments.

The flowcharts and block diagrams in the drawings of this disclosure illustrate the possible architecture, functionality, and operations of systems, methods, and computer program products according to various embodiments disclosed in this disclosure. In this context, each box in the flowchart or block diagram may represent a module, program segment, or part of code, where the module, program segment, or code part contains one or more executable instructions that implement a specified logical function. It should also be noted that, in some alternative implementations, the functions indicated in the boxes can occur in a different order than that shown in the figures. For example, two connected boxes might actually be executed in parallel, and they may sometimes be executed in the opposite order, depending on the functions involved. Furthermore, it is important to note that each box in the block or flowchart, as well as combinations of boxes in the block or flowchart, can be implemented using a dedicated hardware-based system that performs the specified functions or operations, or a combination of dedicated hardware and computer instructions.

Those skilled in the art will appreciate that the features described in the various embodiments and/or claims of this disclosure can be combined and/or incorporated in various ways, even if such combinations or incorporations are not explicitly stated in this disclosure. In particular, without departing from the spirit and teachings of the present application, the features described in the various embodiments and/or claims can be combined and/or incorporated in multiple ways, and all such combinations and/or incorporations are within the scope of the disclosure of this disclosure.

The specific embodiments presented in this document explain the principles and implementation methods of the present invention. The description of the above embodiments is only intended to aid in understanding the methods and core concepts of the present invention and is not meant to limit this disclosure. Those skilled in the art can make changes to the specific implementation methods and application scope based on the ideas, spirit, and principles of the present invention. Any modifications, equivalent substitutions, improvements, and the like made should fall within the scope of protection of this disclosure.

What is claimed is:

1. A task scheduling method, performed by a central controller in a multi-region inter-connected edge network, the multi-region inter-connected edge network further comprising a plurality of network access points respectively in a plurality of regions, the method comprising:
receiving, from each of the plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generating a computing power network graph based on the prediction information for task arrival, the resource allocation information, and the network state information of the plurality of network access points;
determining a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
sending the scheduling strategy to each of the plurality of network access points before the next scheduling cycle begins.

2. The method of claim 1, wherein the determining comprises:
calculating a second scheduling overhead for the next scheduling cycle based on the first scheduling overhead and a pre-determined long-term-average scheduling overhead;
determining the scheduling strategy based on the second scheduling overhead and the computing power network graph.

3. The method of claim 2, wherein the scheduling strategy is represented by a matrix of the scheduling probabilities, and the determining the scheduling strategy based on the second scheduling overhead and the computing power network graph comprises:
by assigning an initial class for each of the plurality of network access points according to a plurality of pre-determined classes, generating a set of candidate class vectors for the plurality of network access points, wherein the pre-determined classes comprise: a source node, a sink node, and an isolated node, the source node has only an out-degree and no in-degree, the sink node has only an in-degree and no out-degree, and the isolated node has neither an out-degree nor an in-degree;
configuring an objective function based on the second scheduling overhead, a scheduling probability, and the computing power network graph;
determining, for each of the set of candidate class vectors, the matrix of the scheduling probabilities by using the objective function; and
selecting an optimal matrix as the scheduling strategy, according to a value of the objective function when determining the matrix of the scheduling probabilities.

4. The method of claim 1, wherein after receiving the scheduling strategy, each of the plurality of network access points determines, according to the scheduling strategy, a target network access point for a task request received from a user terminal, and forwards the task request to the target network access point.

5. The method of claim 4, wherein each of the plurality of network access points determines whether a task request is received from another network access point, and in response to determining the task request is received from another network access point, sends the task request to an edge computing server in a same region to process the task request.

6. The method in claim 1, wherein at the end of a current scheduling cycle, each of the plurality of network access points calculates the first scheduling overhead for each service and reports the first scheduling overhead to the central controller.

7. An electronic device, comprising a memory, a processor, and a computer program stored in the memory that, when executed by the processor, causes the processor to:
receive, from each of a plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generate a computing power network graph based on the prediction information for task arrival, the resource allocation information, and the network state information of the plurality of network access points;
determine a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
send the scheduling strategy to each of the plurality of network access points before the next scheduling cycle begins.

8. A non-transitory computer-readable storage medium, storing a computer program, causing a computer to execute a process, the process comprising:
receiving, from each of a plurality of network access points, first scheduling overhead, prediction information for task arrival, resource allocation information, and network status information, wherein the first scheduling overhead represents a sum of scheduling overhead caused when the respective network access point scheduling a plurality of task requests for a service within a previous scheduling cycle;
generating a computing power network graph based on the prediction information for task arrival, the resource allocation information, and the network state information of the plurality of network access points;
determining a scheduling strategy for a next scheduling cycle based on the first scheduling overhead of the plurality of network access points and the computing power network graph, wherein the scheduling strategy comprises scheduling probabilities of forwarding a task request from one network access point to another network access point; and
sending the scheduling strategy to each of the plurality of network access points before the next scheduling cycle begins.
